(19) United States
(12) Patent Application Publication
(10) Pub. No.: US 2023/0144800 A1
(43) Pub. Date: May 11, 2023

(54) INFORMATION PROCESSING APPARATUS, INFORMATION PROCESSING SYSTEM, AND INFORMATION PROCESSING METHOD

(71) Applicant: Sony Group Corporation, Tokyo (JP)

(72) Inventors: Toshinori KONDO, Tokyo (JP); Futoshi TAKEUCHI, Tokyo (JP); Asako DOI, Tokyo (JP)

(73) Assignee: Sony Group Corporation, Tokyo (JP)

(21) Appl. No.: 17/917,591

(22) PCT Filed: Apr. 19, 2021
(86) PCT No.: PCT/JP2021/015870

§ 371 Date: Oct. 7, 2022

(30) Foreign Application Priority Data
May 20, 2020 (JP) 2020-088489

(51) Int. Cl. H04N 7/18; G06T 17/00

(52) U.S. Cl. CPC H04N 7/183; G06T 17/00; G06T 2210/56

(57) ABSTRACT

An information processing apparatus according to an embodiment of the present disclosure includes a real image signal generator, a CG signal generator, and a. transmission section. The real image signal generator modulates real image data by a first modulation scheme to thereby generate a real image signal. The real image data is obtained by imaging of a surrounding environment. The CG signal generator modulates CG data by a second modulation scheme to thereby generate a CG signal. The CG data is obtained on the basis of data obtained by sensing of the surrounding environment. The transmission section transmits the real image signal and the CG signal to n external device by wireless communication.

### TECHNICAL FIELD

The present disclosure relates to an information processing apparatus, an information processing system, and an information processing method.

### BACKGROUND ART

In a case where a human remotely controls a mobile body such as a robot or a drone, the human operates the mobile body while watching an image captured by the mobile body. For smooth remote control, a low-latency high-definition image is desired. For example, PTL 1 discloses that a transmission data amount is reduced by replacing a less important part included in image data with computer graphics (CG) image data.

### CITATION LIST

### Patent Literature

PTL Japanese Unexamined Patent Application Publication No. 2007-323481

### SUMMARY OF THE INVENTION

However, in the invention described in PTL 1, for example, in some cases such as a case where a proportion of humans in an image is large, a part replaced with CG image data is reduced, resulting in difficulty in reducing the transmission data amount. As described above, it has not been easy to perform smooth remote control. It is therefore desirable to provide an information processing apparatus, an information processing system, and an information processing method that make it possible to perform smooth remote control.

An information processing apparatus according to a first aspect of the present disclosure include a real image signal generator, a CG signal generator, and a transmission section. The real image signal generator modulates real image data by a first modulation scheme to thereby generate a real image signal. The real image data is obtained by imaging of a surrounding environment. The CG signal generator modulates CG data by a second modulation scheme to thereby generate a CG signal. The CG data is obtained on the basis of data obtained by sensing of the surrounding environment. The transmission section transmits the real image signal and the CG signal to an external device by wireless communication.

An information processing system according to a second aspect of the present disclosure includes an information processing apparatus and a remote control device that are configured to be communicable with each other by wireless communication. The information processing apparatus includes a real image signal generator, a CG signal generator, and a transmission section. The real image signal generator modulates real image data by a first modulation scheme to thereby generate a real image signal. The real image data is obtained by imaging of a surrounding environment. The CG signal generator modulates CG data by a second modulation scheme to thereby generate a CG signal. The CG data is obtained on the basis of data obtained by sensing of the surrounding environment. The transmission section transmits the real image signal and the CG signal to the remote control device by wireless communication. The remote control device includes a reception section and a display section. The reception section receives the real image signal and the CG signal transmitted from the information processing apparatus by the wireless communication. The display section displays an image on the basis of at least one of the real image signal or the CCI signal received by the reception section.

An information processing method according to a third aspect of the present disclosure includes the following three.
(A) modulating real image data by a first modulation scheme to thereby generate a real image signal, the real image data being obtained by imaging of a surrounding environment;
(B) modulating CG data by a second modulation scheme to thereby generate a CG signal, the CG data being obtained on the basis of data obtained by sensing of the surrounding environment; and
(C) transmitting the real image signal and the CG signal to an external device by wireless communication.

In the information processing apparatus according to the first aspect of the present disclosure, the information processing system according to the second aspect of the present disclosure, and the information processing method according to the third aspect of the present disclosure, the real image data obtained by imaging of the surrounding environment is modulated by the first modulation scheme to thereby generate the real image signal. The CG data obtained on the basis of the data obtained by sensing of the surrounding environment is modulated by the second modulation scheme to thereby generate the CG signal. The real image data and the CG data are then transmitted to the external device (remote control device). Accordingly, it is possible to modulate two types of data (the real image data and the CG data) having data amounts different from each other by modulation schemes corresponding to the data amounts. As a result, for example, even in a case where image quality is degraded or image display is interrupted due to radio wave interference when performing image display based on the real image data, it is possible to continue image display by switching to image display based on the CG data.

### BRIEF DESCRIPTION OF DRAWINGS

FIG. 1 is a diagram illustrating a schematic configuration example of an information processing system according to a first embodiment of the present disclosure.

FIG. 2 is a diagram illustrating a schematic configuration example of a sensor section and a surrounding environment data extracting section in FIG. 1.

FIG. 3 is a diagram illustrating an example of a surrounding environment.

FIG. 4 is a diagram illustrating an example of a CG image.

FIG. 5 is a diagram illustrating a schematic configuration example of an information processing system according to a second embodiment of the present disclosure.

FIG. 6 is a diagram illustrating a schematic configuration example of an information processing system according to a third embodiment of the present disclosure.

FIG. 7 is a diagram illustrating a modification example of a schematic configuration of the information processing system in FIG. 6.

FIG. 8 is a diagram illustrating a schematic configuration example of an information processing system according to a fourth embodiment of the present disclosure.

### MODES FOR CARRYING OUT THE INVENTION

Hereinafter, description is given in detail of embodiments of the present disclosure with reference to the drawings. It is to be noted that, in the present specification and drawings, repeated description is omitted for components substantially having the same functional configuration by assigning the same reference signs.

### <1. Background>

In a case where a human remotely controls a mobile body such as a robot or a drone, the human operates the mobile body while watching an image captured by the mobile body. For smooth remote control, a low-latency high-definition image is desired. However, a poor communication state for transmission of image data may cause trouble in operation of the mobile body, such as delay in mage display, difficulty in watching an image due to occurrence of an error in image data, or freezing of image display. Specifically, in wireless communication, communication quality degradation due to radio wave interference or space loss of radio waves is an issue. In Peer to Peer wireless communication, reception electric power becomes weaker with increasing distance between the mobile body and a remote control device, eventually resulting in an image not being updated and making the mobile body uncontrollable.

It is possible to cope with an issue concerning a transmission data amount to some extent by compressing image data with use of, for example. AVC (Advanced Video Coding), HEVC (High Efficiency Video Coding), or the like to reduce the transmission data amount. It is to be noted that AVC is a video coding standard standardized by ITU (international Telecommunication Union). HEVC is a video coding standard proposed by JCT-VC (Joint Collaborative Team on Video Coding) that is a group of video coding experts from MPEG of ISO/IEC and VCEG of ITU-T, and is a standard officially called H.265. However, to maintain image quality at a level not to impair operability of the remote control device, the transmission data amount has to be large to some extent.

To cope with the large transmission data amount, for example, high-order modulation of image data is conceivable. However, in a case where high-order modulation of the image data is performed, a CN (Carrier to Noise Ratio) is increased; therefore, interference of radio waves is more apt to occur with a wider frequency band, and a distance at which an image is normally transmittable is decreased.

In the invention described in PTL 1 described above, image data from a photographing device is separated into a target region and a non-target region for CG (computer graphics), and data obtained by converting image data of the target region into CG image data is transmitted by a communication line, and a CG image is generated from the received CG image data, and a combination of the generated CG image of the target region and an image of the non-target region is displayed. Thus, it is possible to reduce the transmission data amount by converting a less important part included in the image data into CG image data. However, in the invention described in PTL 1 described above, a region where a moving object or a human is displayed is a non-target region for conversion into CG; therefore, for example, in some cases such as a case where a proportion of humans in an image is large, a part replaced with CG image data is reduced, resulting in difficulty in reducing the transmission data amount.

In addition, the invention described in Japanese Unexamined Patent Application Publication No. 2000-125194, a terminal device has moving image source data, and combines the moving image source data on the basis of moving image control data received via a communication line, and reproduces a moving image by controlling motion of the moving image source data. This makes it possible to reduce the transmission data amount. However, in this invention, it is not possible to express an unknown region or an obstacle that is not included in the moving image source data in the moving image; therefore, the invention is not suitable for highly versatile remote control with less restrictions on places and uses.

Accordingly, the present disclosure proposes a new technique that allows for highly versatile remote control with less restrictions on places and uses while reducing a transmission data amount.

### <2. First Embodiment>

### [Configuration]

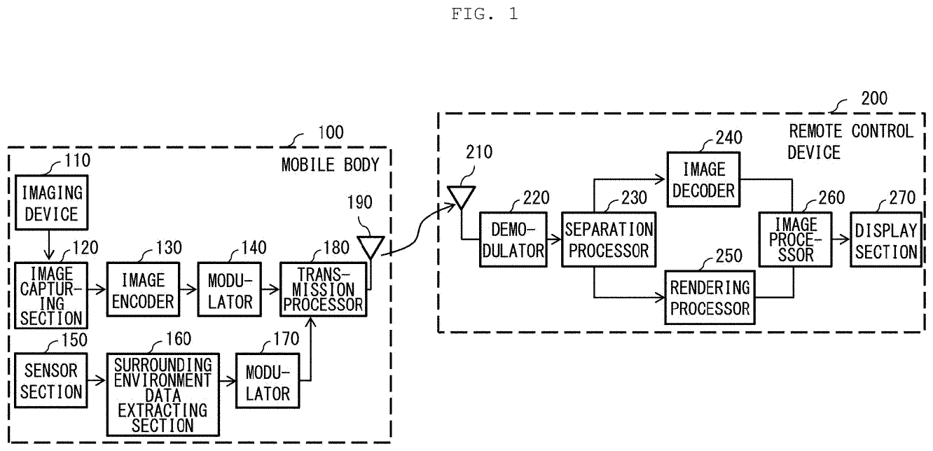

Description is given of an information processing system according to a first embodiment of the present disclosure. FIG. 1 illustrates a schematic configuration example of the information processing system. The information processing system includes a mobile body 100 and a remote control device 200 that are configured to be communicable with each other by Peer to Peer wireless communication.

The mobile body 100 obtains real image data Da having a relatively large data amount by imaging of a surrounding environment, and obtains CG data. Db having a relatively small data amount by sensing of the surrounding environment. The mobile body 100 performs predetermined processing on the obtained real image data Da and the obtained CG data Db to generate transmission data Dt, and transmits the transmission data Dt to the remote control device 200 by wireless communication.

The mobile body 100 includes, for example, an imaging device 110, an image capturing section 120, an image encoder 130, and a modulator 140. The imaging device 110 obtains imaging data by imaging of the surrounding environment. The image capturing section 120 captures the imaging data obtained by the imaging device 110 as a moving image (real image data Da). The imaging device 110 and the image capturing section 120 are configured by a camera capable of photographing a moving image. The image encoder 130 encodes (encodes and compresses) the real image data Da to obtain encoded data di. The modulator 140 generates a real image signal S1 by performing, baseband processing such as error correction encoding or interleaving on the encoded data di and modulating the encoded data d1. The modulator 140 uses, for example, a high-order modulation scheme such as 16QAM (Quadrature Amplitude Modulation) as a modulation scheme. The modulator 140 outputs the generated real image signal S1 to a transmission processor 180 to be described later.

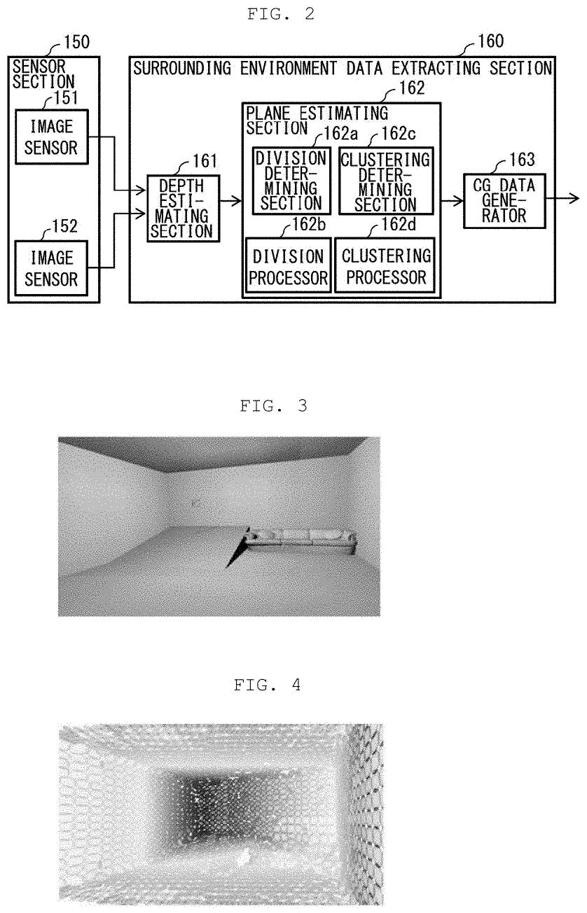

The mobile body 100 further includes a sensor section 150, a surrounding environment data extracting section 160, a modulator 170, the transmission processor 180, and an antenna 190. The sensor section 150 obtains three-dimensional point group data by sensing of the surrounding environment. The sensor section 150 includes, for example, image sensors 151 and 152, as illustrated in FIG. 2. The image sensors 151 and 152 are so-called stereo cameras, and generate one set of image data having parallax relative to each other by imaging of, for example, a region in front of the mobile body 100. The image sensor 151 and the image sensor 152 are disposed apart from each other in a horizontal direction by a predetermined distance. The image sensor 151 is disposed on the left of the image sensor 152, and generates left image data, The image sensor 152 is disposed on the right of the image sensor 151, and generates right image data. The image sensors 151 and 152 perform an imaging operation at a predetermined frame rate in synchronization with each other.

The surrounding environment data extracting section 160 generates map data (CG data Db) by generating three-dimensional point group data on the basis of image data obtained from the sensor section 150, dividing a point group included in the generated three-dimensional point group data, and performing clustering of the divided point group. If necessary, the surrounding environment data extracting section 160 may generate encoded data d2 by encoding (encoding and compressing) the CG data Db. If necessary, the surrounding environment data extracting section 160 may add, for example, color data to the map data (CG data Db) to make appearance of an object such as an obstacle clear.

As illustrated in FIG. 2, the surrounding environment data extracting section 160 includes, for example, a depth estimating section 161, a plane estimating section 162, and a CG data generator 163.

The depth estimating section 161 estimates a depth (distance) to each of image points corresponding to each other in the left image data obtained from the image sensor 151 and the right image data obtained from the image sensor 152 on the basis of the left image data and the right image data. Thus, the depth estimating section 161 generates a depth map. The depth estimating section 161 converts coordinates of each of the image points into, for example, coordinates in a three-dimensional coordinate system on the basis of the depth map obtained by estimation. Thus, the depth estimating section 161 generates three-dimensional point group data.

The plane estimating section 162 generates a microplane group by dividing the point group included in the three-dimensional point group data on the basis of the three-dimensional point group data and performing clustering of the divided point group. Each cluster corresponds to one of a plurality of microplanes configuring a surface of an object around the mobile body 100. The plane estimating section 162 generates cluster data including a plurality of clusters generated in such a manner.

The plane estimating section 162 includes a division determining section 162a, a division processor 162b, a clustering determining section 162c, and a clustering processor 162d.

The division determining section 162a determines whether or not to divide the point group included in the three-dimensional point group data, on the basis of a division condition. The division condition is a condition for determining whether or not to divide the point group, and in a case where the point group satisfies the division condition, the point group is divided. In a case where division determining section 162a determines that the point group satisfies the division condition, the division processor 162b divides the point group until not satisfying the division condition.

In a case where the division determining section 162a determines that the point group does not satisfy the division condition, the clustering determining section 162c determines whether or not to perform clustering of the point group on the basis of a clustering condition. The clustering condition is a condition for determining whether or not to perform clustering of the point group, and in a case where the point group satisfies the clustering condition, clustering of the point group is performed. In a case where the clustering determining section 162c determines that the point group satisfies the clustering condition, the clustering processor 162d performs clustering of the point group.

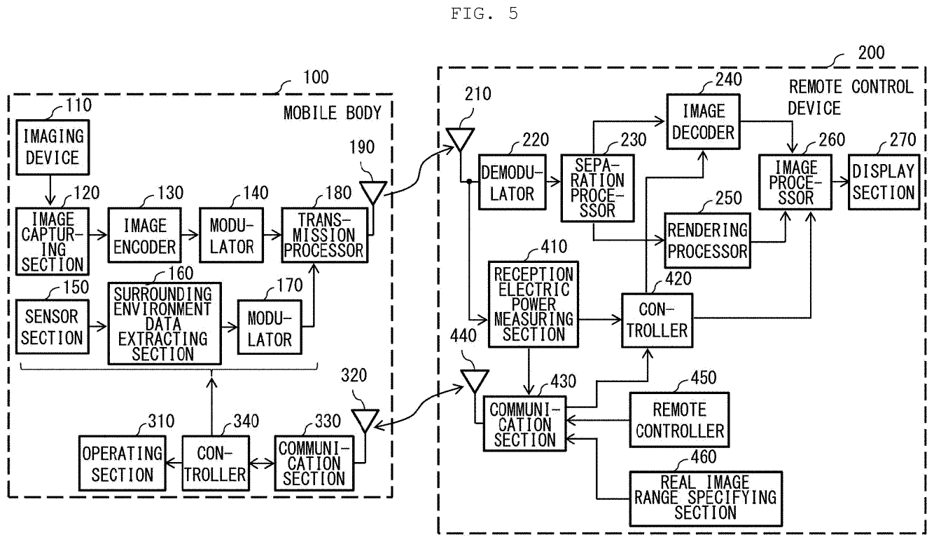

The CG data generator 163 extracts coordinates or sizes of the plurality of clusters obtained by clustering to generate map data (CG data Db) for conversion into a CG image. In a case where the surrounding environment around the mobile body 100 is as illustrated in FIG. 3 for example, a CG image generated from the CG data Db is as illustrated in FIG. 4, for example. It is to be noted that the CG data generator 163 may recognize an object by grouping the plurality of clusters obtained by clustering. The object corresponds to each of objects around the mobile body 100, and is specifically a human, a wall, a floor, or the like around the mobile body 100. The CG data generator 163 may then generate map data (CG data Db) expressed by the plurality of clusters on the basis of the recognized object.

In a case where the mobile body 100 is a traveling robot that travels on a plane, it is possible to convert the CG data Db into two-dimensional data. In a case where the mobile body 100 is a drone that flies in space, it is possible to convert the CG data Db into three-dimensional data. In the CG data Db, each of the clusters is expressed with use of, for example, center coordinates and a probability distribution shape. This makes it possible to reduce a data size of CG data Db and enhance accuracy of the CG data Db as compared with a case where map data is configured with use of a so-called grid map, for example.

The modulator 170 generates a CG signal S2 by performing baseband processing such as error correction encoding or interleaving on the CG data Db (or the encoded data d2) and modulating the CG data Db (or the encoded data d2). The modulator 170 uses, for example, a low-order modulation scheme such as QPSK (Quadrature Phase Shift Keying) as a modulation scheme. The modulator 170 outputs the generated CG signal S2 to the transmission processor 180.

The transmission processor 180 generates the transmission data Dt by performing predetermined processing on the real image signal Si and the CG signal S2, and transmits the generated transmission data Dt to the remote control device 200 via the antenna 190. The transmission processor 180 transmits the real image signal S1 and the CG signal S2 to the remote control device 200 by frequency division or time division, for example. The transmission processor 180 may transmit the real image signal S1, for example, in a predetermined range of a frequency band in a 2-GHz band, and transmit the CG signal S2 in another frequency band in the 2-GHz band. The transmission processor 180 may transmit the real image signal S2, for example, in a frequency band having a relatively wide bandwidth, and transmit the CG signal S2 in a frequency band having a relatively narrow bandwidth. The transmission processor 180 may alternately transmit the real image signal S1 and the CG signal S2, for example, in predetermined time cycles.

The transmission processor 180 transmits the real image signal S1 and the CG signal S2 with use of, for example, OFDM (Orthogonal Frequency Division Multiplexing). At this time, the transmission processor 180 generates an OFDM frame, for example, by hierarchically combining the real image signal S1 and the CG signal S2 and performing time interleaving or frequency interleaving, and performs IFFT operation on the generated OFDM frame. Thus, the transmission processor 180 converts, for example, the real image signal S1 and the CG signal S2 into an OFDM signal. At this time, the transmission processor 180 may divide, for example, a transmission frequency band into some segments, and allocate a relatively large number of segments to the real image signal S1 and allocate a relatively small number of segments to the CG signal S2. Thus, it is possible to decrease a modulation rate of the real image data Da and perform transmission to a farther place, and it is possible to improve a CN of the CG data Db avoiding radio wave interference or increasing electric power density within a range of standards or laws and regulations. As a result, longer-distance transmission is possible. The transmission processor 180 further generates an RF signal (transmission data Dt) by adding a GI (guard interval) to the OFDM signal obtained by conversion and performing up-conversion or the like, and transmits the generated RF signal (transmission data Dt) to the remote control device 200.

It is to be noted that signal processing used in the transmission processor 180 is not limited to OFDM. The transmission processor 180 may add a time stamp signal to each of the real image signal S1 and the CG signal S2. This makes it possible to perform smooth switching without time deviation in the remote control device 200 upon switching from a real image to a CG image or switching from a CG image to a real image.

The remote control device 200 includes, for example, an antenna 210, a demodulator 220, a separation processor 230, an image decoder 240, a rendering processor 250, an image processor 260, and a display section 270. The remote control device 200 receives, for example, the real image signal S1 and the CG signal S2 transmitted by frequency division or time division via the antenna 210. The demodulator 220 demodulates each of the real image signal S1 and the CG signal S2, and outputs the real image signal S1 and the CG signal S2 to the separation processor 230. In a case where the remote control device 200 receives the OFDM signal from the mobile body 100, the demodulator 220 performs, for example, processing such as deinterleaving, descrambling, or error detection/correction processing on the OFDM signal, and outputs a thus-obtained stream including the encoded data d1 and the CG data Db (or the encoded data d2) to the separation processor 230. The separation processor 230 outputs the encoded data d1 to the image decoder 240, and outputs the CG data Db (or the encoded data d2) to the rendering processor 250.

It is to be noted that the demodulator 220 may be provided in a stage subsequent to the separation processor 230. In this case, the separation processor 230 separates the received real image signal S1 and the received CG signal S2, and outputs the real image signal S1 and the CG signal S2 to the demodulator 220.

The image decoder 240 decodes the encoded data d1 to generate the real image data Da, and outputs the real image data Da to the image processor 260. The rendering processor 250 decodes the encoded data d2 if necessary to generate CG data Db. The rendering processor 250 generates CG image data Dc on the basis of the CG data Db, and outputs the CG image data Dc to the image processor 260. The image processor 260 generates image data. Dd for displaying on the display section 270 by selecting one of the real image data Da and the CG image data Dc or combining the real image data Da and the CG image data Dc each other. The image processor 260 generates an image signal based on the generated image data Dd, and outputs the image signal to the display section 270. The display section 270 displays an image (moving image) on the basis of the inputted image signal. The display section 270 may be omitted if necessary. In this case, the image processor 260 outputs the image signal to an external device including the display section 270, and the external device displays an image (moving image) based on the image signal.

### [Effects]

Next, description is given of effects of the information processing system according to the embodiment.

In the present embodiment, the real image data Da obtained by imaging of the surrounding environment is modulated by a relatively high-order modulation scheme to thereby generate the real image signal S1, and map data (CG data Db) obtained on the basis of data obtained by sensing of the surrounding environment is modulated by a relatively low-order modulation scheme to thereby generate the CG signal S2. The real image data Da and the CG data Db are then transmitted to the remote control device 200. Accordingly, two types of data (the real image data Da and the CG data Db) having data amounts different from each other are modulated by modulation schemes corresponding to the data amounts. Thus, even in a case where image quality is degraded or image display is interrupted due to radio wave interference when performing image display based on the real image data Da, it is possible to continue image display by switching to image display based on the CG data Db. As a result, a user is able to remotely control the mobile body 100 smoothly while switching the type of a displayed image in accordance with the state of radio wave interference.

In the present embodiment, the real image signal is modulated with use of a relatively high-order modulation scheme, and the CG signal is modulated with use of a relatively low-order modulation scheme. This allows the CG signal S2 to be transmitted to a farther place than the real image signal S1, which makes it possible to smoothly perform long-distance remote control.

In the present embodiment, the real image signal S1 is transmitted in a frequency band having a relatively wide bandwidth, and the CG signal S2 is transmitted in a frequency band having a relatively narrow bandwidth. Accordingly, for example, even in a case where image quality is degraded or image display is interrupted due to radio wave interference when performing image display based on the real image data Da, it is possible to continue image display by switching to image display based on the CG data Db. In addition, the CG signal S2 is allowed to be transmitted to a farther place than the real image signal S1, which makes it possible to smoothly perform long-distance remote control.

### <3. Second Embodiment>

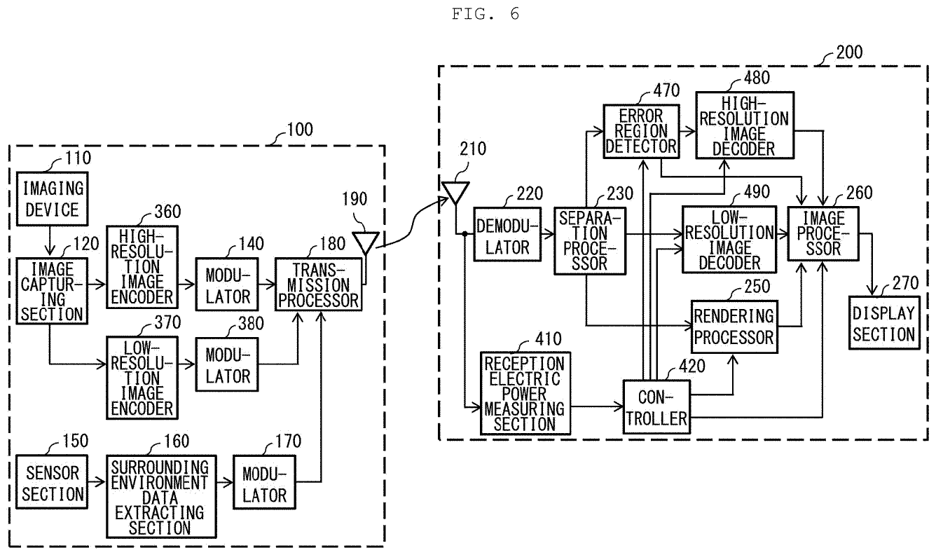

Next, description is given of an information processing system according to a second embodiment of the present disclosure. FIG. 5 illustrates a schematic configuration example of the information processing system according to the present embodiment. The information processing system according to the present embodiment includes the mobile body 100 and the remote control device 200.

In the present embodiment, the mobile body 100 further includes, for example, an operating section 310, an antenna 320, a communication section 330, and a controller 340 in addition to components from the imaging device 110 to the antenna 190,

The operating section 310 includes, for example, an actuator and a moving mechanism. The actuator generates, for example, power in accordance with control by the controller 340, and drives the moving mechanism on the basis of the power. The moving mechanism moves the mobile body 100 on the basis of the power generated by the actuator. Thus, the mobile body 100 moves in accordance with control by the controller 340. Here, in a case where the mobile body 100 is a traveling robot that travels on a plane, the moving mechanism includes, for example, one or a plurality of wheels. In a case where the mobile body 100 is a drone, the moving mechanism includes, for example, one or a plurality of propellers.

The communication section 330 performs communication with the remote control device 200 via the antenna 320. Communication with the remote control device 200 via the antenna 320 is, for example, wireless communication different from the wireless communication via the antennas 190 and 210. Communication with the remote control device 200 via the antenna 320 is, for example, Peer to Peer wireless communication, it is to be noted that all communications between the mobile body 100 and the remote control device 200 may be performed by one wireless communication.

The controller 340 controls an operation of the operating section 310 on the basis of operation data Do inputted from the remote control device 200 via the antenna 320. The operation data Do is data generated in a remote controller 450 to be described later. The controller 340 controls real image range specification processing in the image capturing section 120 on the basis of at least real image range specification data Dr of the real image range specification data Dr and reception electric power data Dp inputted from the remote control device 200 via the antenna 320. The real image range specification data Dr is data generated in a real image range specifying section 460 to be described later. The real image range specification processing is described in detail later.

In the present embodiment, the remote control device 200 further includes, for example, a reception electric power measuring section 410, a controller 420, a communication section 430, an antenna 440, the remote controller 450, and the real image range specifying section 460 in addition to components from the antenna 210 to the display section 270.

The remote controller 450 receives input of the operation data Do from the user, and outputs the received operation data Do to the communication section 430. The communication section 430 transmits the operation data Do inputted from the remote controller 450 to the mobile body 100 via the antenna 440. The remote controller 450 is, for example, an input interface that is capable of receiving input of the operation data Do from the user, and includes, for example, a touch panel, a keyboard, a mouse, and the like.

The real image range specifying section 460 receives input of the real image range specification data Dr from the user, and outputs the received real image range specification data Dr to the communication section 430. The reception electric power measuring section 410 measures electric power of a signal received by the antenna 210, and outputs a value (reception electric power data Dp) obtained by such measurement to the controller 420 and the communication section 430. It is to be noted that the reception electric power measuring section 410 may measure electric power of a signal outputted from the demodulator 220, and output a value (reception electric power data Dp) obtained by such measurement to the controller 420 and the communication section 430. The communication section 430 transmits the inputted real image range specification data Dr and the inputted reception electric power data. Dp to the mobile body 100 via the antenna. 440. The remote controller 450 is, for example, an input interface that is capable of receiving input of the real image range specification data Dr from the user, and includes, for example, a touch panel, a keyboard, a mouse, and the like.

If necessary, the controller 420 may determine which one of the read image data. Da and the CG image data Dc is to be selected on the basis of the reception electric power data Dp inputted from the reception electric power measuring section 410, and output a result of such determination to the image processor 260. In this case, the image processor 260 selects one of the real image data. Da and the CG image data Dc in accordance with the result of determination inputted from the controller 420 to generate the image data Dd.

The controller 420 may further generate a control signal for stopping the operation of the image encoder 240 when selecting the CG image data Dc and output the control signal to the image decoder 240. This stops the operation of the image decoder 240 while selecting the CG image data Dc to reduce electric power consumption by the image decoder 240. The controller 420 may further generate a control signal for stopping the operations of the imaging device 110, the image capturing section 120, the image encoder 130, and the modulator 140 of the mobile body 100 when selecting the CG image data Dc, and output the control signal to the communication section 430. In this case, the communication section 430 transmits the control signal inputted from the controller 420 to the mobile body 100 via the antenna 440. Upon receiving the control signal from the remote control device 200 via the antenna 320, the communication section 330 outputs the thus-received control signal to the controller 340. The controller 340 stops the operations of the imaging device 110, the image capturing section 120, the image encoder 130, and the modulator 140 on the basis of the control signal inputted from the remote control device 200. Thus, electric power consumption by the imaging device 110, the image capturing section 120, the image encoder 130, and the modulator 140 is reduced.

The controller 420 may output the reception electric power data Dp to the communication section 430, if necessary. In this case, the communication section 430 transmits the reception electric power data Dp inputted from the controller 420 to the mobile body 100 via, the antenna 440. Upon receiving the reception electric power data Dp from the remote control device 200 via the antenna 440. the communication section 330 outputs the thus-received reception electric power data Dp to the controller 340. Upon obtaining the reception electric power data Dp from the remote control device 200, the controller 340 determines a compression rate on the basis of the obtained reception electric power data Dp, and outputs setting data for setting to the determined compression rate to the image encoder 130. The image encoder 130 compresses the real image data Da at a compression rate corresponding to the setting data inputted from the controller 340. That is, the controller 340 and the image encoder 130 adjust the compression rate of the real image data Da on the basis of the reception electric power data Dp.

Upon obtaining the reception electric power data Dp from the remote control device 200, the controller 340 may determine image resolution on the basis of the obtained reception electric power data. Dp, and output setting data for setting to the determined image resolution to the image capturing section 120. At this time, the image capturing section 120 adjusts the resolution of the real image data Da on the basis of the setting data inputted from the controller 340. The image capturing section 120 changes, for example, the resolution of the real image data Da to image resolution corresponding to the setting data inputted from the controller 340, and outputs the real image data Da having changed image resolution to the image encoder 130. That is, the controller 340 and the image capturing section 120 adjust the resolution of the real image data Da on the basis of the reception electric power data Dp.

Upon obtaining the reception electric power data Dp from the remote control device 200, the controller 340 may determine a division size of a cluster on the basis of the obtained reception electric power data Dp, and output setting data for setting to the determined division size to the surrounding environment data extracting section 160. At this time, the surrounding environment data extracting section 160 performs clustering of the point group with a division size corresponding to the setting data inputted from the controller 340.

### (Real Image Range Specification Processing)

Next, description is given of the real image range specification processing. The controller 340 outputs, for example, the real image range specification data Dr to the image capturing section 120, the image encoder 130, and the modulator 140. The image capturing section 120 processes the real image data Da on the basis of the inputted real image range specification data Dr to thereby generate real image data Da′ in which a real image range is limited, and outputs the generated real image data Da′ to the image encoder 130. The image capturing section 120 cuts out, for example, data (in-range data Dx) within a range (specified range) specified by the real image range specification data Dr from the real image data Da, replaces data (out-range data Dy) within a range other than the specified range of the real image data Da with single-color background data, and outputs thus-obtained real image data Da′ to the image encoder 130. It is to be noted that the specified range is not limited to one part and may include a plurality of parts.

The image encoder 130 encodes and compresses the real image data Da′ to obtain encoded data d1′. At this time, the data amount of the encoded data d1′ is decreased with an increase in the specified range. Accordingly, the image encoder 130 may change the compression rate in accordance with the real image range specification data. Dr (the size of the specified range). The modulator 140 may change a modulation scheme to be performed on the encoded data d1′ in accordance with the real image range specification data Dr (the size of the specified range). In a case where the data amount of the encoded data d1′ is smaller than a predetermined amount, the modulator 140 may modulate the encoded data d1′ with use of a low-order modulation scheme such as QPSK (Quadrature Phase Shift Keying). The modulator 140 modulates the encoded data dr to thereby generate a real image signal S1, and outputs the real image signal S1′ to the transmission processor 180. The transmission processor 180 transmits the real image signal S1′ in place of the real image signal S1 to the remote control device 200 via the antenna 190.

The remote control device 200 receives, for example, the real image signal S1′ and the CG signal S2 via the antenna 210, The demodulator 220 demodulates each of the real image signal S1′ and the CG signal S2, and outputs the real image signal S1′ and the CG signal S2 to the separation processor 230. The separation processor 230 outputs the encoded data d1′ obtained by demodulation of the real image signal S1′ to the image decoder 240, and outputs the CG data Db (or the encoded data d2) to the rendering processor 250. The image decoder 240 generates the real image data Da′ by decoding the encoded data d1′, and outputs the real image data Da′ to the image processor 260. If necessary, the rendering processor 250 generates the CG data Db by decoding the encoded data d2. The rendering processor 250 generates the CG image data Dc on the basis of the CG data Db. and outputs the CG image data. Dc to the image processor 260.

The image processor 260 separates the data (in-range data Dx) within the range specified by the real image range specification data Dr from the real image data Da′, and writes the in-range data Dx obtained by such separation over the CG image data Dc, thereby generating image data Dd′ for displaying on the display section 270. The image processor 260 generates an image signal based on the generated image data Dd′, and outputs the image signal to the display section 270. The display section 270 displays an image (a moving image) on the basis of the inputted image signal.

It is to be noted that the controller 340 may output, for example, the real image range specification data Dr and the reception electric power data Dp to the image encoder 130. In this case, the image encoder 130 may determine the compression rate on the basis of the inputted real image range specification data Dr and the inputted reception electric power data Dp, and compress the real image data Da′ at the determined compression rate. For example, in a case where the reception electric power is low and the specified range is side, the image encoder 130 may compress the real image data Da′ at a high compression rate. For example, in a case where the reception electric power is low and the specified range is narrow, the image encoder 130 may compress the real image data Da′ at a lowest possible compression rate within a communicable range. That is, the controller 340 and the image encoder 130 adjust the compression rate of the real image data Da! on the basis of the real image range specification data Dr and the reception electric power data Dp. This makes it possible to perform image display with high quality in the remote control device 200.

It is to be noted that the real image range specification data Dr may be determined by an operation by the user in the real image range specifying section 460 as described above, or may be automatically specified without depending on the operation by the user. For example, it is assumed that the image capturing section 120 has a function of recognizing an obstacle or an operation-target object included in the real image data Da. At this time, in a case where the image capturing section 120 has already obtained an object that is desired to be recognized by setting, learning, or the like, the target object included in the real image data Da is recognized, and it is determined difficult or impossible to transmit the entire real image data Da due to low reception electric power, a range including the target object may be automatically specified as a real image range, and the specified real image range may be set as the real image range specification data Dr.

### [Effects]

Next, description is given of effects of the information processing system according to the embodiment.

In the present embodiment, the real image data Da is processed on the basis of the real image range specification data Dr to thereby generate limited real image data (real image data Da′) in which the real image range is limited, and the generated real image data Da′ is modulated by the same modulation scheme as the modulation scheme of the real image data Da or a lower-order modulation scheme than the modulation scheme of the real image data Da. This makes it possible to easily perform remote control of a delicate operation or movement that is not easy to control with use of a CG image.

In the present embodiment, the resolution or the compression rate of the real image data Da is adjusted on the basis of the reception electric power data Dp. This makes it possible to reduce the data amount of the real image signal S1, thereby achieving image display with highest possible definition. As a result, it is possible to perform smooth remote control.

### <4. Third Embodiment>

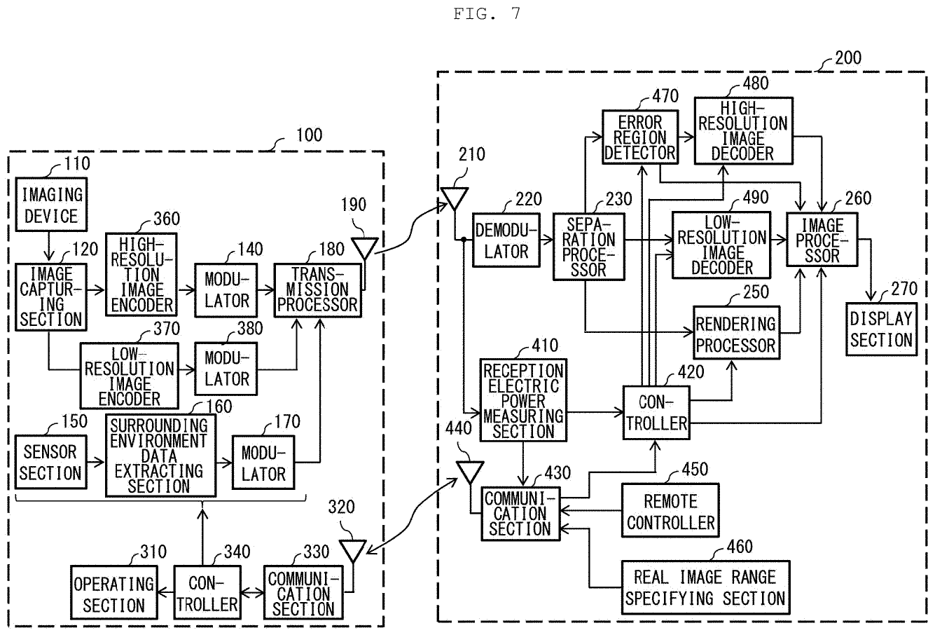

Next, description is given of an information processing system according to a third embodiment of the present disclosure. FIG. 6 illustrates a schematic configuration example of the information processing system according to the present embodiment. The information processing system according to the present embodiment includes the mobile body 100 and the remote control device 200.

In the present embodiment, the mobile body 100 differs from the mobile body 100 according to the first embodiment described above in that a high-resolution image encoder 360 is included in place of the image encoder 130, and a low-resolution image encoder 370 and a modulator 380 are newly included. In the present embodiment, the image capturing section 120 generates real image data (low-resolution image data De) having lower resolution than the real image data Da on the basis of the real image data Da. The image capturing section 120 generates the low-resolution image data De, for example, by sampling the real image data Da.

Similarly to the image encoder 130, the high-resolution image encoder 360 obtains the encoded data d1 by encoding and compressing the real image data Da. In contrast, the low-resolution image encoder 370 obtains encoded data d3, for example, by encoding and compressing the generated low-resolution image data De. The modulator 380 generates a real image signal S3 by performing baseband processing such as error correction encoding or interleaving on the encoded data d3 and modulating the encoded data d3 by a predetermined modulation scheme.

The data amounts of the real image data Da, the low-resolution image data De, and the CG data Db are as follows, The modulators 140, 380, and 170 may set a modulation rate in accordance with the data amounts.
Da_s>De_s>Db_s
Da_s: Data amount of real image data Da
De_s: Data amount of low-resolution image data De
Db_s: Data amount of CG data Db

The transmission processor 180 transmits the real image signal S1 having relatively high resolution, the real image signal S3 having relatively low resolution, and the CG signal S2 to the remote control device 200 via the antenna 190. The transmission processor 180 transmits the real image signal S1, the real image signal S3, and the CG signal S2 to the remote control device 200 by frequency division or time division. The transmission processor 180 performs transmission of the real image signal S1, the real image signal S3, and the CG signal S2 with use of, for example, OFDM.

In the present embodiment, the remote control device 200 differs from the remote control device 200 according to the first embodiment described above in that, for example, a high-resolution image decoder 480 is included in place of the image decoder 240. In the present embodiment, the remote control device 200 further includes, for example, an error region detector 470, a low-resolution image decoder 490, a reception electric power measuring section 410, and a controller 420.

The remote control device 200 receives the real image signal S1, the real image signal S3, and the CG signal S2, for example, via the antenna 210. The demodulator 220 demodulates each of the real image signal S1, the real image signal S3, and the CG signal S2, and outputs the real image signal S1, the real image signal S3, and the CG signal S2 to the separation processor 230, In a case where the remote control device 200 receives an OFDM signal from the mobile body 100, the demodulator 220 performs, for example, processing such as deinterleaving, descrambling, or error detection/correction processing on the OFDM signal, and outputs a thus-obtained stream including the encoded data d1 and d3 and the CG data Db (or the encoded data d2) to the separation processor 230. The separation processor 230 outputs the encoded data d1 to the error region detector 470, outputs the encoded data d3 to the low-resolution image decoder 490. and outputs the CG data Db (or the encoded data d2) to the rendering processor 250.

The error region detector 470 determines whether or not an image error is included in the encoded data di, and in a case where the image error is included, the error region detector 470 outputs data (error region data d4) about a region where an error point is present to the image processor 260. The high-resolution image decoder 480 generates the real image data Da by decoding the encoded data d1, and outputs the real image data Da to the image processor 260. The low-resolution image decoder 490 generates the low-resolution image data De by decoding the encoded data d3, and outputs the low-resolution image data De to the image processor 260. If necessary, the rendering processor 250 generates the CG data Db by decoding the encoded data d2. The rendering processor 250 generates the CG image data Dc on the basis of the CG data Db, and outputs the CG image data Dc to the image processor 260.

The image processor 260 generates image data Dd for displaying on the display section 270 by selecting one of the real image data Da, the low-resolution image data De, and the CG image data Dc or combining one of the real image data Da and the low-resolution image data De, and the CG image data Dc with each other. At this time, in a case where the image processor 260 receives the error region data d4 from the error region detector 470, the image processor 260 extracts image data (partial image data Df) of the region where the error point is present in the real image data Da from the low-resolution image data De on the basis of the error region data d4, and writes the extracted partial image data Df over the real image data Da to thereby generate image data Dd″ for displaying on the display section 270. It is to be noted that the image processor 260 may generate the image data Dd″ by cutting out a region Re where the error point is present from the real image data Da on the basis of the error region data d4 and inserting the partial image data Df into the region Re for combination. The image processor 260 generates an image signal based on the generated image data Dd″, and outputs the image signal to the display section 270. The display section 270 displays an image (moving image) on the basis of the inputted image signal.

In a case where the region Re where the error point is present in the real image data Da is increased and exceeds a predetermined threshold, the image processor 260 may generate the image data Dd without using the real image data Da. In a case where the region Re exceeds the predetermined threshold, the image processor 260 may generate the image data Dd, for example, by selecting the low-resolution image data De as the image data Dd or combining the low-resolution image data De and the CG image data Dc with each other. It is to be noted that in a case where the region Re is present in the real image data Da (e.g., in a case where the error region data d4 is inputted), the image processor 260 may generate the image data Dd without using the real image data Da by a method similar to the above-described method.

If necessary, the controller 420 may determine which one of the read image data Da and the CG image data Dc is to be selected on the basis of the reception electric power data Dp inputted from the reception electric power measuring section 410, and output a result of such determination to the image processor 260. in this case, the image processor 260 selects one of the real image data Da and the CG image data Dc in accordance with the result of determination inputted from the controller 420 to generate the image data Dd.

The controller 420 may further generate a control signal for stopping the operations of the error region detector 470, the high-resolution image decoder 480, and the low-resolution image decoder 490 when selecting the CG image data Dc, and output the control signal to the high-resolution image decoder 480 and the low-resolution image decoder 490. Accordingly, the operations of the high-resolution image decoder 480 and the low-resolution image decoder 490 while selecting the CG image data De are stopped to reduce electric power consumption by the high-resolution image decoder 480 and the low resolution image decoder 490.

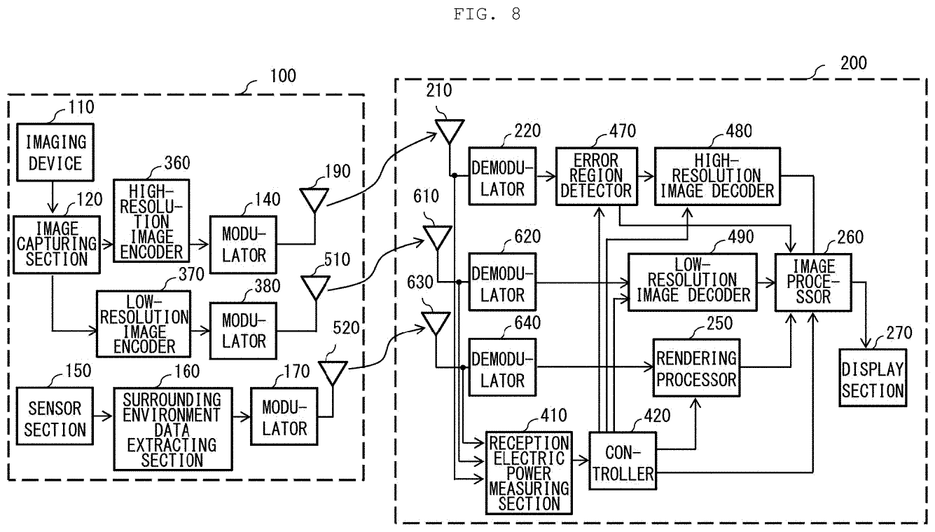

It is to be noted that the information processing system according to the present embodiment may have, for example, wireless communication via the antennas 320 and 430 in addition to wireless communication via the antennas 190 and 210, as illustrated in FIG. 7.

in this case, the controller 420 may generate a control signal for stopping the operations of the imaging device 110, the image capturing section 120, the high-resolution image encoder 360, the low-resolution image encoder 370, the modulator 140, and the modulator 380 of the mobile body 100 when selecting the CG image data Dc, and output the control signal to the communication section 430. The communication section 430 transmits the control signal inputted from the controller 420 to the mobile body 100 via the antenna 440. Upon receiving the control signal from the remote control device 200 via the antenna 320, the communication section 330 outputs the received control signal to the controller 340. The controller 340 stops the operations of the imaging device 110, the image capturing section 120, the image encoder 130, and the modulator 140 on the basis of the control signal inputted from the remote control device 200. Thus, electric power consumption by the imaging device 110, the image capturing section 120, the image encoder 130, and the modulator 140 is reduced.

### [Effects]

Next, description is given of effects of the information processing system according to the embodiment.

In the present embodiment, the low-resolution real image data De that is generated on the basis of the real image data Da and has lower resolution than the real image data Da is modulated by a predetermined modulation scheme to thereby generate the real image signal S3 having low resolution. Accordingly, for example, even in a case where image quality is degraded or image display is interrupted due to radio wave interference when performing image display based on the real image data Da, it is possible to switch to image display based on the low-resolution real image data De having relatively high definition without suddenly switching to image display based on the CG data Db of a coarse image. As a result, it is possible to increase time in which a real image is displayable, which makes it possible to smoothly perform remote control of the mobile body 100.

it is to be noted that in the information. processing system according to the present embodiment, one piece of low-resolution image data (low-resolution image data De) is generated from the real image data Da. However, in the information processing system according to the present embodiment, two or more pieces of low-resolution image data may be generated from the real image data Da.

In addition, in the information processing system according to the present embodiment, one piece of CG data Db is generated from output of the sensor section 150. However, in the information processing system according to the present embodiment, two or more pieces of CG data may be generated from output of the sensor section 150.

### <5. Fourth Embodiment>

Next, description is given of an information processing system according to a fourth embodiment of the present disclosure. FIG. 8 illustrates a schematic configuration example of the information processing system according to the present embodiment. The information processing system according to the present embodiment includes the mobile body 100 and the remote control device 200.

In the present embodiment, the mobile body 100 differs from the mobile body 100 according to the third embodiment described above in that the transmission processor 180 is omitted, and antennas 510 and 520 are newly included. In the present embodiment, the remote control device 200 differs from the remote control device 200 according to the third embodiment described above in that the separation processor 230 is omitted, and antennas 610 and 630 and demodulators 620 and 640 are newly included.

The modulator 140 transmits the real image signal S1, for example, in a relatively highest frequency band (e.g., 5-GHz hand) to the antenna 210 of the remote control device 200 via the antenna 190. The modulator 170 transmits the CG signal S2, for example, in a relatively lowest frequency band (e.g., 900-MHz band) to the antenna 630 of the remote control device 200 via the antenna 520. The modulator 380 transmits the real image signal S3, for example, in a frequency band (e.g., 2-GHz band) between transmission frequency bands of the real image signal S1 and the CG signal S2 to the antenna 610 of the remote control device 200 via the antenna 510.

The demodulator 220 receives the real image signal S1 transmitted, for example, in the relatively highest frequency band (e.g., 5-GHz band) via the antenna 210. The demodulator 640 receives the CG signal S2 transmitted, for example, in the relatively lowest frequency band (e.g., 900-MHz) via the antenna 630. The demodulator 640 demodulates the CG signal S2, and outputs the CG signal S2 to the rendering processor 250. The demodulator 620 receives the real image signal S3 transmitted, for example, in the frequency band (e.g., 2-GHz band) between the transmission frequency bands of the real image signal S1 and the CG signal S2 via the antenna 610. The demodulator 620 demodulates the real image signal S3, and outputs the real image signal S3 to the low-resolution image decoder 490.

As a frequency increases, straightness of radio waves becomes higher, and propagation loss in space becomes larger. Conversely, as the frequency decreases, sneak of radio waves due to diffraction more easily occurs, and the propagation loss is decreased, which makes it easier for radio waves to reach. In contrast, data capacity is easily increased at a high frequency that easily has a wide frequency bandwidth, and is decreased at a low frequency of which the frequency bandwidth tends to be narrow. Transmitting high-resolution image data (real image signal S1) at a high frequency makes it possible to perform high-definition image display by high data capacity. Transmitting low-resolution image data (real image signal S3) at a low frequency makes it possible to perform minimum image display necessary for control. Long-distance transmission is implemented by transmitting CG data (CG signal S2) at the lowest frequency, and at least CG data (CG signal S2) is transmitted with highest reliability. Accordingly, even if a real image is not able to be displayed, a distance allowing for control is increased.

### [Effects]

Next, description is given of effects of the information processing system according to the embodiment.

In the present embodiment, the real image signal S1 and the real image signal S3 are transmitted in a relatively high frequency band, and the CG signal S2 is transmitted in a relatively low frequency band. This makes it possible to transmit at least the CG signal S2 with highest reliability; therefore, even in a case where a real image is not able to be displayed, it is possible to increase a distance or time in which the mobile body 100 is remotely controllable.

In the present embodiment, the real image signal S1 is transmitted in the relatively highest frequency band, the CG signal S2 is transmitted in the relatively lowest frequency band, and the real image signal S3 is transmitted in the frequency band between the transmission frequency bands of the real image signal S1 and the CG signal S2. This makes it possible to transmit at least the CG signal S2 with highest reliability, and further makes it possible to transmit the real image signal S3 having higher definition than the CG signal S2 in a case where a communication state is not so poor. Accordingly, even in a case where a real image haying extremely high definition based on the real image signal S1 is not able to be displayed, it is possible to increase a distance or time in which the mobile body 100 is remotely controllable without impairing operability as much as possible.

It is to be noted that in the present embodiment, data transmission by wireless communication using three sets of antennas may be replaced with data transmission by wireless communication using one set of antennas corresponding to multiple hands. In such a case, it is sufficient if output terminals of three modulators 140, 380, and 170 are coupled to a triplexer or the like, one antenna is provided at an output terminal of the triplexer, input terminals of three demodulators 220, 620, and 640 are coupled to a triplexer or the like, and one antenna is provided at an input terminal of the triplexer.

In addition, in the present embodiment, data transmission is performed by wireless communication using three sets of antennas; however, for example, in the present embodiment, data transmission by wireless communication using four or more sets of antennas may be performed.

It is to be noted that in the embodiments described above and modification examples thereof, the mobile body 100 may include a sound sensor section that senses sounds of the surrounding environment, a force sensor section that senses a force sense supplied from the surrounding environment. In this case, the modulator 170 may generate a sound signal or a force sense signal by performing baseband processing such as error correction encoding and interleaving on sound data obtained from the sound sensor section or force sense data obtained from the force sensor section and modulating the sound data and the force sense data, and transmit the sound signal or the force sense signal to the remote control device 200.

In addition, for example, the present disclosure may have the following configurations.

(1)

An information processing apparatus including:
a real image signal generator that modulates real image data by a first modulation scheme to thereby generate a real image signal, the real image data being obtained by imaging of a surrounding environment;
a CG signal generator that modulates CG (computer graphics) data by a second modulation scheme to thereby generate a CG signal, the CG data being obtained on the basis of data obtained by sensing of the surrounding environment; and a transmission section that transmits the real image signal and the CG signal to an external device by wireless communication.
   (2)

The information processing apparatus according to (1), in which the transmission section modulates the real image signal with use of a relatively high-order modulation scheme as the first modulation scheme, and modulates the CG signal with a relatively low-order modulation scheme as the second modulation scheme.

(3)

The information processing apparatus according to (1) or (2), in which the transmission section transmits the real image signal in a frequency band having a relatively wide bandwidth, and transmits the CG signal in a frequency band having a relatively narrow bandwidth.

(4)

The information processing apparatus according to any one of (1) to (3), further including a reception section that receives real image range specification data that specifies a predetermined range in a real image generated on the basis of the real image signal, in which
the real image signal generator processes the real image data on the basis of the real image range specification data to thereby generate limited real image data in which a range of the real image is limited, and modulates the generated limited real image data by the first modulation scheme or a lower-order modulation scheme than the first modulation scheme.
   (5)

The information processing apparatus according to any one of (1) to (4), further including a reception section that receives reception electric power data from the external device, in which
the real image signal generator adjusts resolution or a compression rate of the real image data on the basis of the reception electric power data.
   (6)

The information processing apparatus according to any one of (1) to (5), in which the real image signal generator modulates low-resolution real image data having lower resolution than the real image data by a third modulation scheme to thereby generate a low-resolution real image signal, the low-resolution real image data being generated on the basis of the real image data, and
the transmission section transmits the real image signal, the low-resolution real image signal, and the CG signal to the external device by the wireless communication.
   (7)

The information processing apparatus according to any one of (1) to (5), in which the transmission section transmits the real image signal in a relatively high frequency band, and transmits the CG signal in a relatively low frequency band.

(8)

The information processing apparatus according to (6), in which the transmission section transmits the real image signal in a relatively highest frequency hand, transmits the CG signal in a relatively lowest frequency band, and transmits the low-resolution real image signal in a frequency band between transmission frequency bands of the real image signal and the CG signal.

(9)

An information processing system including:
an information processing apparatus and a remote control device that are configured to be communicable with each other by wireless communication,
the information processing apparatus including:
a first generator that modulates real image data by a first modulation scheme to thereby generate a real image signal, the real image data being obtained by imaging of a surrounding environment,
a second generator that modulates CG (computer graphics) data by a second modulation scheme to thereby generate a CG signal, the CG data being obtained on the basis of data obtained by sensing of the surrounding environment, and
a first transmission section that transmits the real image signal and the CG signal to the remote control device by wireless communication, and
the remote control device including:
a first reception section that receives the real image signal and the CG signal transmitted from the information processing apparatus by the wireless communication, and
a display section that displays an image on the basis of at least one of the real image signal or the CG signal received by the reception section.
   (10)

The information processing system according to (9), in which
the remote control device further includes
a third generator that generates real image range specification data that specifies a predetermined range in a real image to be displayed on the display section on the basis of the real image signal, and
a second transmission section that transmits the real image range specification data generated by the third generator to the remote control device by wireless communication,
the information processing apparatus further includes a second reception section that receives the real image range specification data from the remote control device, and the real image signal generator processes the real image data on the basis of the real image range specification data received by the second reception section to thereby generate limited real image data in which a range of the real image is limited, and modulates the generated limited real image data by the first modulation scheme or a lower-order modulation scheme than the first modulation scheme.
   (11)

The information processing system according to (9) or (10), in which
the remote control device further includes:
a reception electric power measuring section that measures electric power of a signal transmitted from the information processing apparatus or a signal obtained by performing predetermined processing on the signal transmitted from the information processing apparatus to thereby obtain electric power data, and
a third transmission section that transmits the electric power data obtained by the reception electric power measuring section to the remote control device by wireless communication,
the information processing apparatus further includes a third reception section that receives the electric power data from the remote control device by wireless communication, and
the real image signal generator adjusts resolution of e real image data on the basis of the reception electric power data.
   (12)

An information processing method including:
modulating real image data by a first modulation scheme to thereby generate a real image signal, the real image data being obtained by imaging of a surrounding environment;
modulating CG (computer graphics) data by a second modulation scheme to thereby generate a CG signal, the CG data being obtained on the basis of data obtained by sensing of the surrounding environment; and
transmitting the real image signal and the CG signal to an external device by wireless communication.

In an information processing apparatus according to a first aspect of the present disclosure, an information processing system according to a second aspect of the present disclosure, and an information processing method according to a third aspect of the present disclosure, real image data obtained by imaging of a surrounding environment is modulated by a first modulation scheme to thereby generate a real image signal. CG data obtained on the basis of data obtained by sensing of the surrounding environment is modulated by a second modulation scheme to thereby generate a CG signal. The real image data and the CG data are then transmitted to an external device (remote control device). Accordingly, it is possible to modulate two types of data (the real image data and the CG data) having data amounts different from each other by modulation schemes corresponding to the data amounts. As a result, for example, even in a case where image quality is degraded or image display is interrupted due to radio wave interference when

performing image display based on the real image data, it is possible to continue image display by switching to image display based on the CG data. Thus, a user is able to remotely control a mobile body smoothly while switching the type of a displayed image in accordance with the state of radio wave interference.

This application claims the benefit of Japanese Priority Patent Application JP2020-088489 filed with Japan Patent Office on May 20, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An information processing apparatus comprising:
a real image signal generator that modulates real image data by a first modulation scheme to thereby generate a real image signal, the real image data being obtained by imaging of a surrounding environment;
a CG signal generator that modulates CG (computer graphics) data by a second modulation scheme to thereby generate a CG signal, the CG data being obtained on a basis of data obtained by sensing of the surrounding environment; and
a transmission section that transmits the real image signal and the CG signal to an external device by wireless communication.

2. The information processing apparatus according to claim 1, wherein the transmission section modulates the real image signal with use of a relatively high-order modulation scheme as the first modulation scheme, and modulates the CG signal with a relatively low-order modulation scheme as the second modulation scheme.

3. The information processing apparatus according to claim 1, wherein the transmission section transmits the real image signal in a frequency band having a relatively wide bandwidth, and transmits the CG signal in a frequency band having a relatively narrow bandwidth.

4. The information processing apparatus according to claim 1, further comprising a reception section that receives real image range specification data that specifies a predetermined range in a real image generated on a basis of the real image signal, wherein the real image signal generator processes the real image data on a basis of the real image range specification data to thereby generate limited real image data in which a range of the real image is limited, and modulates the generated limited real image data by the first modulation scheme or a lower-order modulation scheme than the first modulation scheme.

5. The information processing apparatus according to claim 1, further comprising a reception section that receives reception electric power data from the external device, wherein
the real image signal generator adjusts resolution or a compression rate of the real image data on a basis of the reception electric power data.

6. The information processing apparatus according to claim 1, wherein
the real image signal generator modulates low-resolution real image data having lower resolution than the real image data by a third modulation scheme to thereby generate a low-resolution real image signal, the low-resolution real image data being generated on a basis of the real image data, and
the transmission section transmits the real image signal, the low-resolution real image signal, and the CG signal to the external device by the wireless communication.

7. The information processing apparatus according to claim 1, wherein the transmission section transmits the real image signal in a relatively high frequency band, and transmits the CG signal in a relatively low frequency band.

8. The information processing apparatus according to claim 6, wherein the transmission section transmits the real image signal in a relatively highest frequency band, transmits the CG signal in a relatively lowest frequency band, and transmits the low-resolution real image signal in a frequency band between transmission frequency bands of the real image signal and the CG signal.

9. An information processing system comprising:
an information processing apparatus and a remote control device that are configured to he communicable with each other by wireless communication,
the information processing apparatus including:
a first generator that modulates real image data by a first modulation scheme to thereby generate a real image signal, the real image data being obtained by imaging of a surrounding environment,
a second generator that modulates CG (computer graphics) data by a second modulation scheme to thereby generate a CG signal, the CG data being obtained on a basis of data obtained by sensing of the surrounding environment, and
a first transmission section that transmits the real image signal and the CG signal to the remote control device by wireless communication, and
the remote control device including:
a first reception section that receives the real image signal and the CG signal transmitted from the information processing apparatus by the wireless communication, and
a display section that displays an image on a basis of at least one of the real image signal or the CG signal received by the reception section.

10. The information processing system according to claim 9, wherein
the remote control device further includes
a third generator that generates real image range specification data that specifies a predetermined range in a real image to be displayed on the display section on a basis of the real image signal, and
a second transmission section that transmits the real image range specification data generated by the third generator to the remote control device by wireless communication,
the information processing apparatus further includes a second reception section that receives the real image range specification data from the remote control device, and
the real image signal generator processes the real image data on a basis of the real image range specification data received by the second reception section to thereby generate limited real image data in which a range of the real image is limited, and modulates the generated limited real image data by the first modulation scheme or a lower-order modulation scheme than the first modulation scheme.

11. The information processing system according to claim 9, wherein
the remote control device further includes:
a reception electric power measuring section that measures electric power of a signal transmitted from the information processing apparatus or a signal obtained by performing predetermined processing on the signal transmitted from the information processing apparatus to thereby obtain electric power data, and
a third transmission section that transmits the electric power data obtained by the reception electric power measuring section to the remote control device by wireless communication,
the information processing apparatus further includes a third reception section that receives the electric power data from the remote control device by wireless communication, and
the real image signal generator adjusts resolution of the real image data on a basis of the reception electric power data.

12. An information processing method comprising:
modulating real image data by a first modulation scheme to thereby generate a real image signal, the real image data being obtained by imaging of a surrounding environment;
modulating CG (computer graphics) data by a second modulation scheme to thereby generate a CG signal, the CG data being obtained on a basis of data obtained by sensing of the surrounding environment; and
transmitting the real image signal and the CG signal to an external device by wireless communication.
